(19) United States
(12) Patent Application Publication
(10) Pub. No.: US 2016/0373338 A1
(43) Pub. Date: Dec. 22, 2016

(54) STORAGE APPARATUS, CONTROL METHOD, AND CONNECTION DEVICE

(71) Applicant: FUJITSU LIMITED, Kawasaki-shi (JP)

(72) Inventor: Toshihiko Suzuki, Kawasaki (JP)

(73) Assignee: FUJITSU LIMITED, Kawasaki-shi (JP)

(21) Appl. No.: 15/164,150

(22) Filed: May 25, 2016

(30) Foreign Application Priority Data
Jun. 17, 2015 (JP) 2015-121912

(51) Int. Cl. H04L 12/761; H04L 12/407; H04L 12/861; H04L 12/751

(52) U.S. Cl. CPC H04L 45/16; H04L 45/10; H04L 12/407; H04L 49/90

(57) ABSTRACT

A storage apparatus includes a relay device; a connection device coupled to the relay device through a bus; and a plurality of target devices coupled to the connection device, wherein the connection device is configured to: switch an operation mode of the relay device to a first mode to activate a path between the relay device and the one target device, when communication is performed between the connection device and one of the plurality of target devices, and switch the operation mode of the relay device to a second mode to activate paths between the relay device and the two or more target devices, when communication is simultaneously performed between the connection device and two or more of the plurality of target devices.

### CROSS-REFERENCE TO RELATED APPLICATION

This application is based upon and claims the benefit of priority of the prior Japanese Patent Application No. 2015-121912, filed on Jun. 17, 2015, the entire contents of which are incorporated herein by reference.

### FIELD

The embodiments discussed herein are related to a storage apparatus, a control method, and a connection device.

### BACKGROUND

A storage apparatus or an electronic apparatus such as a computer includes various devices therein. The electronic apparatus may control the devices by connecting the devices to each other through a bus in the electronic apparatus. The bus is an inter-integrated circuit (I2C), for example.

For example, there has been proposed an I2C bus circuit including an I2C bus master device coupled to one main I2C bus, a multiplexer module configured to separate the main I2C bus into a number of sub I2C buses, and I2C bus slave devices coupled to the sub I2C buses. In this proposal, when starting communication with the I2C bus slave device, the I2C bus master device selects any one of the paths with an I2C bus multiplexer to communicate with the target I2C bus slave device, thereby removing the restrictions on the number of devices coupled to the I2C bus.

For example, there has also been a proposal in which, during broadcast transmission of data from one transmission node to a plurality of reception nodes through a serial bus, addresses of the plurality of reception nodes are added in a transmission frame including data to be transmitted. In this proposal, when normally receiving the data and confirming their own addresses, the reception nodes each return a reception response signal. The related art is disclosed, for example, in Japanese Laid-open Patent Publication No. 11-96090, Japanese Laid-open Patent Publication No. 2005-4607, and the like.

A case is considered where a connection source device (connection device) is coupled to a plurality of target devices (for example, slave devices) through a relay device (for example, a multiplexer). In this case, as in the above proposal, communication between the connection device and the target devices is performed by the relay device selecting communication paths on the target side one by one.

However, the above method has a problem with time taken for the connection device to communicate with the plurality of devices. For example, the connection device may transmit common data to a plurality of devices (such as a case where common operation settings are performed to the respective devices). In this case, it is inefficient that the same data is transmitted over and over again every time the communication paths on the target side are selected and changed one by one. When the path is selected or the same data is transmitted more than once by the connection device, it takes time to complete the transmission to all the destination devices. Therefore, it is desirable for the connection device to be able to efficiently communicate with the plurality of devices.

### SUMMARY

According to an aspect of the invention, a storage apparatus includes a relay device; a connection device coupled to the relay device through a bus; and a plurality of target devices coupled to the connection device, wherein the connection device is configured to: switch an operation mode of the relay device to a first mode to activate a path between the relay device and the one target device, when communication is performed between the connection device and one of the plurality of target devices, and switch the operation mode of the relay device to a second mode to activate paths between the relay device and the two or more target devices, when communication is simultaneously performed between the connection device and two or more of the plurality of target devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a connection device according to a first embodiment;

FIG. 2 is a diagram illustrating an information processing system according to a second embodiment;

FIG. 3 is a diagram illustrating a module example of a storage apparatus;

FIG. 4 is a diagram illustrating a hardware example of the storage apparatus;

FIG. 5 is a diagram illustrating a hardware example of an I2C control unit and an I2C multiplexer;

FIG. 6 is a diagram illustrating a hardware example of a repeater;

FIG. 7 is a diagram illustrating an example of an I2C bus;

FIG. 8 is a diagram illustrating an example of a timing chart of the I2C bus;

FIGS. 9A and 9B are diagrams illustrating examples of a communication format of the I2C bus;

FIGS. 10A and 10B are diagrams illustrating examples of registers in the I2C multiplexer;

FIG. 11 is a diagram illustrating an example of a buffer in the I2C multiplexer;

FIG. 12 is a flowchart illustrating an example of write processing by the I2C control unit;

FIG. 13 is a flowchart illustrating an example of write processing by the I2C multiplexer;

FIG. 14 is a diagram illustrating a sequence example of the write processing;

FIG. 15 is a diagram illustrating a comparative example of the sequence of the write processing;

FIG. 16 is a flowchart illustrating another example of retransmission processing by the I2C control unit;

FIG. 17 is a flowchart illustrating an example of read processing by the I2C control unit;

FIG. 18 is a flowchart illustrating an example of read processing by the I2C multiplexer; and

FIG. 19 is a diagram illustrating a sequence example of the read processing.

### DESCRIPTION OF EMBODIMENTS

Hereinafter, embodiments are described with reference to the drawings.

### First Embodiment

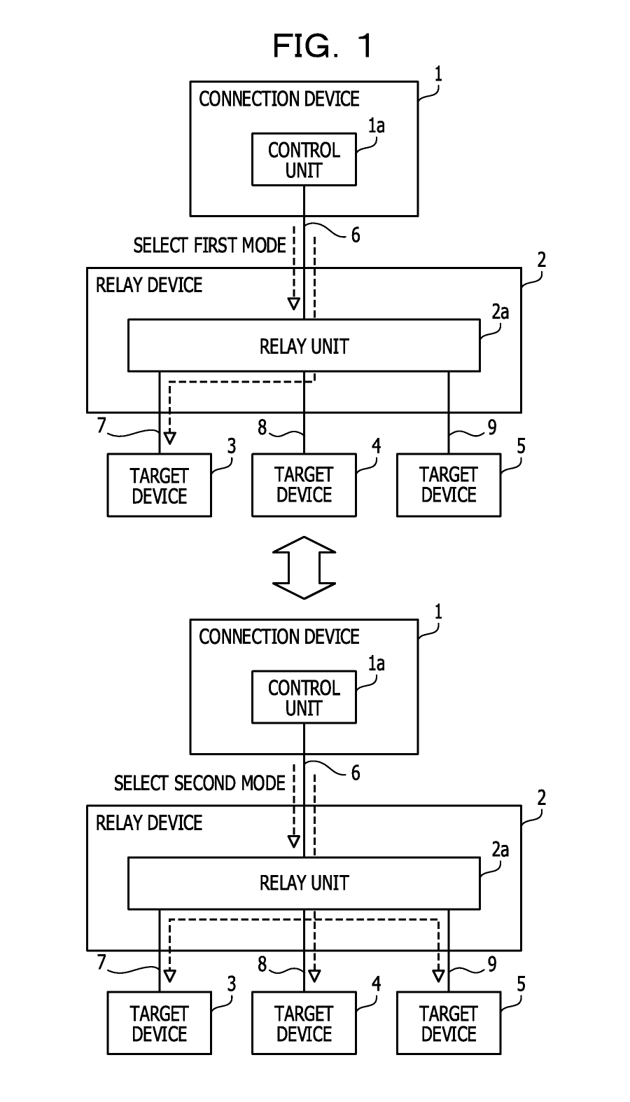

FIG. 1 is a diagram illustrating a connection device according to a first embodiment. A connection device 1 communicates with target devices 3, 4, and 5 through a relay device 2. The connection device 1 and the relay device 2 are coupled to each other through a bus 6. The relay device 2 and the target device 3 are coupled to each other through a bus 7. The relay device 2 and the target device 4 are coupled to each other through a bus 8. The relay device 2 and the target device 5 are coupled to each other through a bus 9.

The buses 6, 7, 8, and 9 are data transmission buses connecting between the devices. The buses 6, 7, 8, and 9 are I2C, for example. The I2C is a two-line bidirectional serial bus using two signal lines of serial clock (SCL) and serial data (SDA). The relay device 2 is an I2C multiplexer, for example.

The connection device 1 includes a control unit 1a. The control unit 1a is realized by a processor such as a central processing unit (CPU), a digital signal processor (DSP), an application specific integrated circuit (ASIC), and a field programmable gate array (FPGA), for example.

The relay device 2 includes a relay unit 2a. The relay unit 2a relays communication between the connection device 1 and the target devices 3, 4, and 5. The relay unit 2a may operate in two operation modes. The first mode is a mode to communicate with one of the target devices 3, 4, and 5. The second mode is a mode to simultaneously communicate with two or more of the target devices 3, 4, and 5.

The control unit is switches the operation mode of the relay unit 2a (which may also be described as the operation mode of the relay device 2) to the first mode or the second mode. For example, during data transmission to only the target device 3 among the target devices 3, 4, and 5, the control unit is instructs the relay unit 2a to select the first mode. Furthermore, the control unit 1a instructs the relay unit 2a to activate only the path to the target device 3. Then, the path between the relay device 2 and the target device 3 (the path formed by the bus 7) is made available. On the other hand, the path between the relay device 2 and the target device 4 (the path formed by the bus 8) and the path between the relay device 2 and the target device 5 (the path formed by the bus 9) are made unavailable. In this state, the control unit is may communicate with only the target device 3.

Meanwhile, the control unit is may also transmit the same data to all the target devices 3, 4, and 5, for example. This is, for example, a case where common operation settings are performed for the target devices 3, 4, and 5. In this event, the control unit is instructs the relay unit 2a to select the second mode. Then, the relay device 2 makes the paths to the target devices 3, 4, and 5 available. In this state, the control unit is may communicate with all the target devices 3, 4, and 5. In the I2C, for example, the same device address may be given to a plurality of target devices. For example, a common device address is given to the target devices 3, 4, and 5. The control unit is designates the common device address as a destination device address, and transmits data once. Then, the relay unit 2a simultaneously transmits the data to the target devices 3, 4, and 5 through the buses 7, 8, and 9. This is an example of the case where the data is transmitted to all the target devices 3, 4, and 5. As another example, the data may also be transmitted to any two of the target devices. In such a case, the control unit is may instruct the relay unit 2a which one of the paths to activate, in addition to the instruction to select the second mode.

As described above, the control unit is switches the operation mode of the relay device 2 between the first mode to communicate with one of the target devices 3, 4, and 5 and the second mode to simultaneously communicate with two or more of the target devices 3, 4, and 5. Thus, the connection device 1 may perform efficient communication according to communication contents.

For example, the same data may be transmitted to the respective target devices, such as the case where the connection device 1 performs common operation settings for the target devices 3, 4, and 5. In this case, the paths on the target side (the paths formed by the buses 7, 8, and 9) may be selected one by one, and corresponding data may be transmitted by the connection device 1 upon each selection. However, it is inefficient that the same data is transmitted over and over again from the connection device 1 every time the path is selected and changed. When the path is selected or the same data is transmitted more than once by the connection device, it takes time to complete the transmission to all the target devices 3, 4, and 5.

Meanwhile, when transmitting the same data to the target devices 3, 4, and 5, the connection device 1 may change the operation mode of the relay device 2 to the second mode and then transmit the data once to the relay device 2. Then, the relay device 2 transmits the data to the target devices 3, 4, and 5. Therefore, the path may not be changed or the same data may not be transmitted more than once from the connection device 1. Thus, the time taken to complete the data transmission to all the target devices 3, 4, and 5 may be reduced.

The target devices 3, 4, and 5 may return a positive response (acknowledgement: ACK) or a negative response (negative acknowledgement: NACK) as reception confirmation. In such a case, the relay unit 2a returns ACK to the connection device 1, for example, upon receipt of ACK from all the target devices 3, 4, and 5. Alternatively, the relay unit 2a returns NACK to the connection device 1 upon receipt of NACK from at least one of the target devices 3, 4, and 5. Then, upon receipt of NACK, the control unit is retransmits the data. This method may improve reliability of data transmission to the target devices 3, 4, and 5.

The connection device 1, the relay device 2, and the target devices 3, 4, and 5 may be included in various apparatuses. For example, the connection device 1, the relay device 2, and the target devices 3, 4, and 5 may be modules or a part of the module included in a storage apparatus.

### Second Embodiment

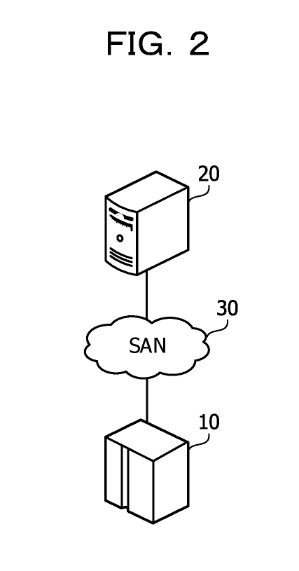

FIG. 2 is a diagram illustrating an information processing system according to a second embodiment. The information processing system according to the second embodiment includes a storage apparatus 10 and a business server 20. The storage apparatus 10 and the business server 20 are coupled to a storage area network (SAN) 30.

The storage apparatus 10 stores business data to be used in processing by the business server 20. The storage apparatus 10 includes a plurality of storage devices such as a hard disk drive (HDD) or a solid state drive (SSD), and makes available a large-capacity storage area. For example, the storage apparatus 10 may achieve faster and more reliable data access by using a plurality of storage devices and a technology called redundant arrays of inexpensive disks (RAID).

The business server 20 is a server computer to execute various kinds of software to be used in business of a user. For example, the user may request the business server 20 to execute business processing, by operating a client computer (not illustrated) coupled to a network (not illustrated) accessible to the business server 20. The business server 20 accesses the storage apparatus 10 through the SAN 30 according to the business processing. According to the business processing, the business server 20 newly stores business data in the storage apparatus 10, reads the business data from the storage apparatus 10 or updates the business data in the storage apparatus 10.

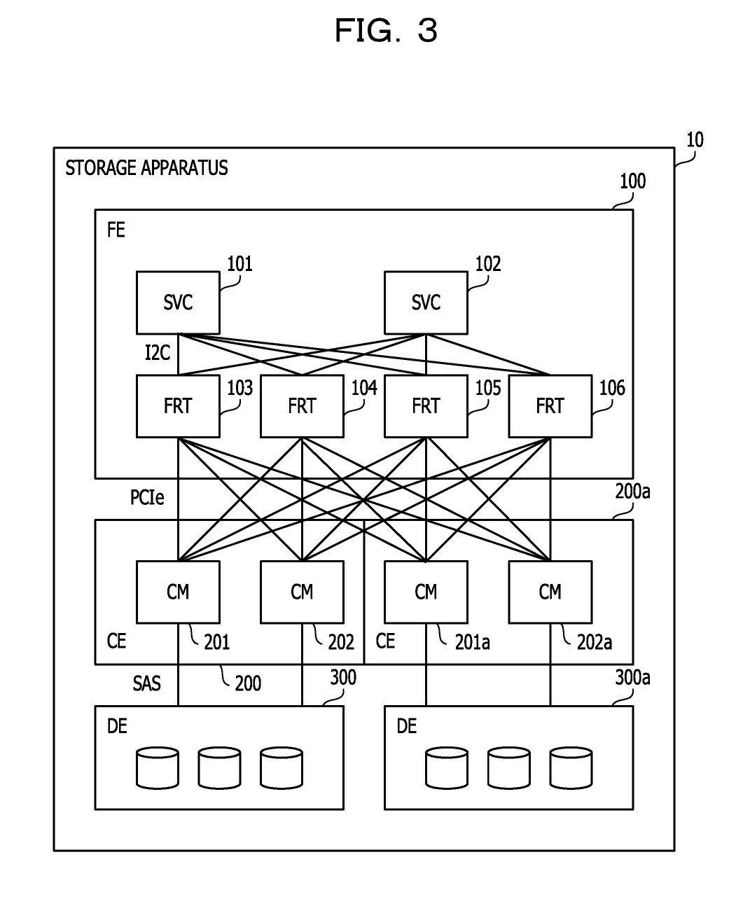

FIG. 3 is a diagram illustrating a module example of the storage apparatus. The storage apparatus 10 includes a front enclosure (FE) 100, controller enclosures (CE) 200 and 200a, and drive enclosures (DE) 300 and 300a.

The FE 100 manages operations of the CEs 200 and 200a. The FE 100 relays communication between the CEs 200 and 200a. The FE 100 includes service controllers (SVC) 101 and 102, and frontend routers (FRT) 103, 104, 105, and 106.

The SVCs 101 and 102 perform power control, redundancy management, and the like for the CEs 200 and 200a. The SVCs 101 and 102 are also coupled to the CEs 200 and 200a. However, the connection between the SVCs and the CEs is not illustrated in FIG. 3. The SVCs 101 and 102 are coupled to the FRTs 103, 104, 105, and 106, respectively. Buses between the SVCs and the FRTs are, for example, I2C buses. The FRTs 103, 104, 105, and 106 relay communication between the CEs 200 and 200a. Buses between the FRTs and the CEs are, for example, peripheral component interconnect expresses (PCIe).

The CEs 200 and 200a control access to business data stored in the DEs 300 and 300a. The CE 200 includes CMs 201 and 202. The CMs 201 and 202 are coupled to the DE 300. Buses between the CMs and the DEs are serial attached SCSI (SAS) (SCSI is an abbreviation for Small Computer System Interface). The CMs 201 and 202 write and read business data to and from a storage device included in the DE 300. The CMs 201 and 202 are made redundant. Even when one of the CMs 201 and 202 breaks down, the other one may continue the data access to the DE 300.

The CE 200a includes CMs 201a and 202a. The CMs 201a and 202a are coupled to the DE 300a. The CMs 201a and 202a write and read business data to and from a storage device included in the DE 300a. The CMs 201a and 202a are made redundant. Even when one of the CMs 201a and 202a breaks down, the other one may continue the data access to the DE 300a. The CMs 201, 202, 201a, and 202a are also coupled to the SAN 30 (not illustrated in FIG. 3).

In the storage apparatus 10, the FE 100 may also be made redundant for each of the CEs 200 and 200a. For example, the DEs 300 and 300a store common data, respectively. Then, even when one of the CEs 200 and 200a breaks down, the other one may continue the data access to the DE 300 or 300a and reduce the chance of stopping the business.

Here, in order to make the communication between the CE and CE (between the CM and CM) more reliable, the paths between the FE and the CEs are also made redundant. To be more specific, the FRTs 103, 104, 105, and 106 are coupled to the CMs 201, 202, 201a, and 202a, respectively. In such connection, the SVCc 101 and 102 perform serializer/deserializer (SerDes) setting and physical settings (setting of signal strength according to the cable length, and the like) regarding the PCIe communication between the FRTs and the CMs, for the FRTs 103, 104, 105, and 106. Here, the following description is given of the case where the SVC 101 performs the setting of the FRT 103. However, the same applies to the case where the SVC 101 performs the setting of another FRT. The SVC 102 may also perform the setting of each FRT in the same manner as the SVC 101. The SVCs 101 and 102 may share the setting of the FRTs 103, 104, 105, and 106 (for example, the SVC 101 performs the setting of the FRTs 103 and 104 and the SVC 102 performs the setting of the FRTs 105 and 106, and the like).

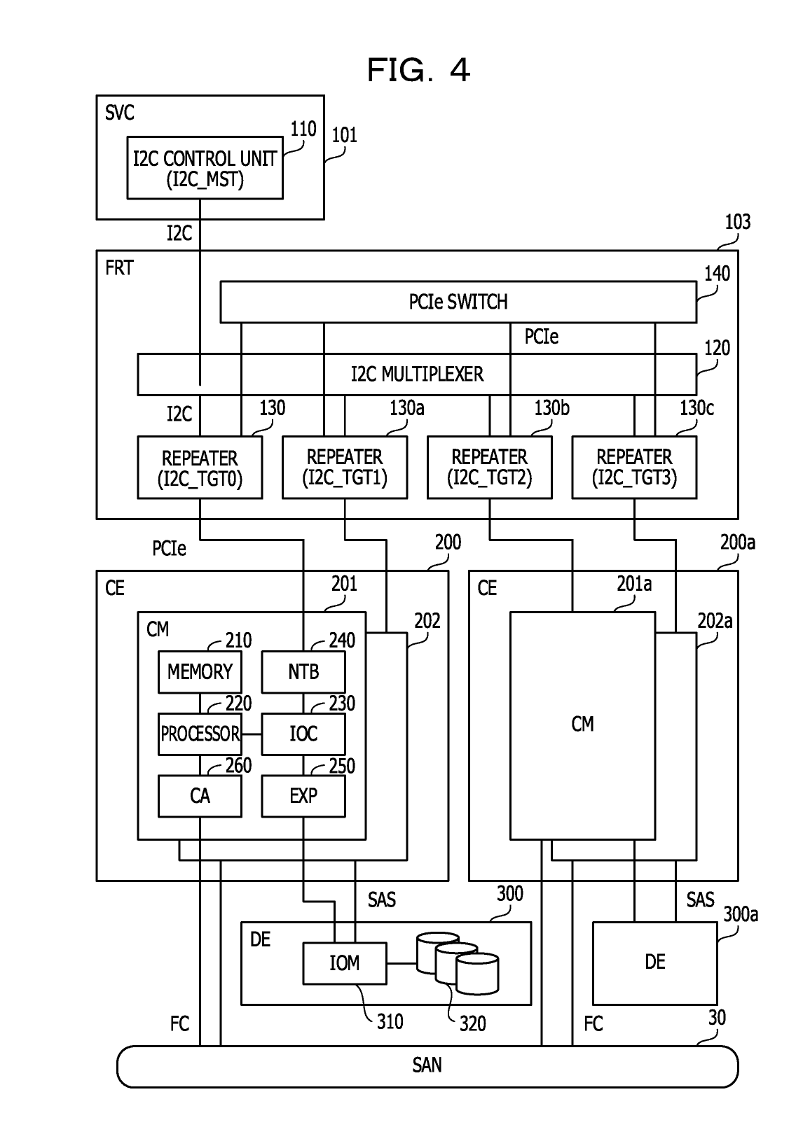

FIG. 4 is a diagram illustrating a hardware example of the storage apparatus. The SVC 101 includes an I2C control unit 110. The I2C control unit 110 functions as an I2C master device. The I2C master device may be abbreviated as the I2C_MST. The I2C control unit 110 may also be described as the I2C_MST or I2C_MST. The I2C control unit 110 controls communication with the I2C target devices (which may also be called the I2C slave devices).

The FRT 103 includes an I2C multiplexer 120, repeaters 130, 130a, 130b, and 130c, and a PCIe switch 140. The I2C multiplexer 120 is a relay device configured to relay communication between the I2C control unit 110 and the repeaters 130, 130a, 130b, and 130c. The I2C multiplexer 120 is coupled to the I2C control unit 110 through an I2C bus. The I2C multiplexer 120 is coupled to the repeaters 130, 130a, 130b, and 130c through I2C buses, respectively. The I2C multiplexer 120 may also be described as the I2C_MUX or I2C MUX.

The repeaters 130, 130a, 130b, and 130c are repeaters configured to relay communication between the CMs. The repeaters 130, 130a, 130b, and 130c may also be considered as communication units configured to relay the communication between the CMs. The repeaters and the CMs are coupled to each other through PCIe buses. The repeater 130 is coupled to the CM 201. The repeater 130a is coupled to the CM 202. The repeater 130b is coupled to the CM 201a. The repeater 130c is coupled to the CM 202a. The repeaters 130, 130a, 130b, and 130c are I2C target devices for the I2C control unit 110. The repeater 130 may also be described as the I2C_TGT0 or I2C TGT0. The repeater 130a may also be described as the I2C_TGT1 or I2C TGT1. The repeater 130b may also be described as the I2C_TGT2 or I2C TGT2. The repeater 130c may also be described as the I2C_TGT3 or I2C TGT3. The repeaters 130, 130a, 130b, and 130c are an example of the target devices 3, 4, and 5 according to the first embodiment.

The PCIe switch 140 is a PCIe switch coupled to the repeaters 130, 130a, 130b, and 130c. The PCIe switch 140 and the respective repeaters are coupled to each other through PCIe buses.

The CE 200 includes the CMs 201 and 202. The CM 201 includes a memory 210, a processor 220, an input/output controller (IOC) 230, a non transparent bridge (NTB) 240, and an expander (EXP) 250. The respective modules in the CM 201 may also be made redundant to improve fault tolerance. The CM 202 is also realized by the same hardware as that of the CM 201.

The memory 210 stores firmware programs to be executed for processing by the processor 220. The memory 210 is a combination of a non-volatile memory such as a flash memory and a volatile memory such as a random access memory (RAM), for example.

The processor 220 controls entire operations of the CM 201. The processor 220 is, for example, a CPU, a DSP, an ASIC, an FPGA or the like.

The IOC 230 controls transmission and reception of data to and from another CM through the NTB 240 and the FRT 103 or transmission and reception of data to and from the DE 300 through the EXP 250.

The NTB 240 is an interface for connecting to the FRT 103 through a PCIe bus. The NTB 240 is coupled to the repeater 130.

The EXP 250 is an interface for connecting to the DE 300 through the SAS.

A CA 260 is an interface for connecting to the SAN 30 through a fibre channel (FC).

The CE 200a includes the CMs 201a and 202a. The CMs 201a and 202a are also realized by the same hardware as that of the CM 201.

The DE 300 includes an input/output module (IOM) 310 and a storage group 320. The DE 300a is also realized by the same hardware as that of the DE 300.

Upon request of the CMs 201 and 202, the IOM 310 writes business data to the storage group 320 or reads the business data from the storage group 320. Then, the IOM 310 returns the result to the CMs 201 and 202. The storage group 320 is the assembly of an HDD, an SSD, and the like to store the business data.

FIG. 4 illustrates the hardware of the SVC 101 and omits the illustration of the SVC 102. However, the SVC 102 also has the same hardware as that of the SVC 101. FIG. 4 illustrates the hardware of the FRT 103 and omits the illustration of the FRTs 104, 105, and 106. However, the FRTs 104, 105, and 106 also have the same hardware as that of the FRT 103.

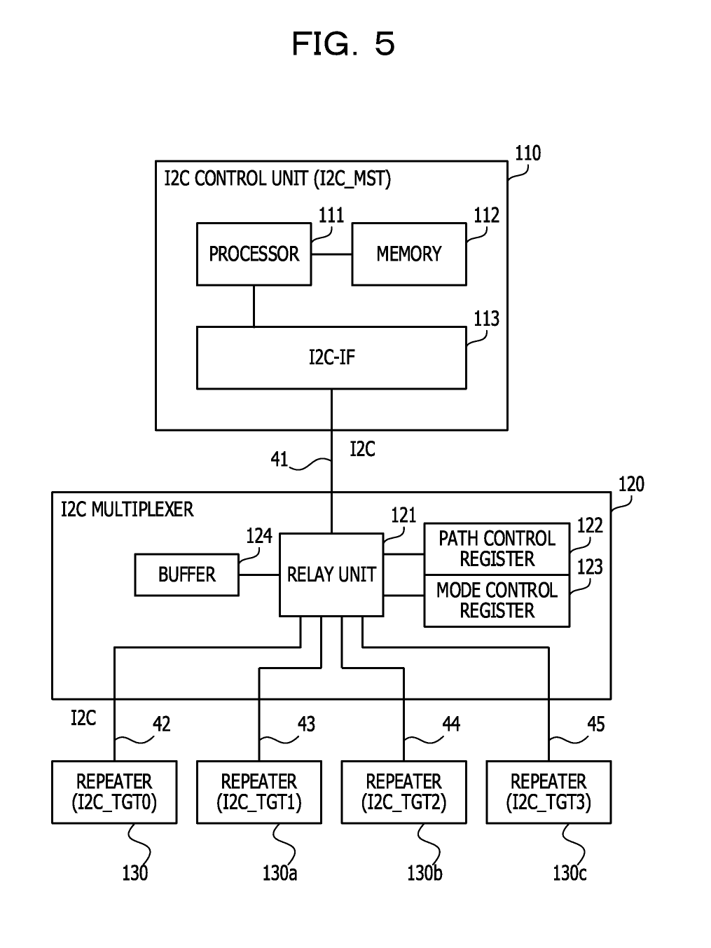

FIG. 5 is a diagram illustrating a hardware example of the I2C control unit and the I2C multiplexer. Here, an I2C bus 41 is an I2C bus for connecting the I2C control unit 110 to the I2C multiplexer 120. An I2C bus 42 is an I2C bus for connecting the I2C multiplexer 120 to the repeater 130. An I2C bus 43 is an I2C bus for connecting the I2C multiplexer 120 to the repeater 130a. An I2C bus 44 is an I2C bus for connecting the I2C multiplexer 120 to the repeater 130b. An I2C bus 45 is an I2C bus for connecting the I2C multiplexer 120 to the repeater 130c.

The I2C control unit 110 includes a processor 111, a memory 112, and an I2C-IF (InterFace) 113.

The processor 111 controls operations of the I2C control unit 110. The processor 111 is, for example, a CPU, a DSP, an ASIC, an FPGA or the like.

The memory 112 stores data to be used for processing by the processor 111. The memory 112 may be a combination of a non-volatile memory such as a flash memory and a volatile memory such as a RAM.

The I2C-IF 113 is an interface for connecting to the I2C bus 41. The I2C-IF 113 is coupled to the I2C multiplexer 120 through the I2C bus 41.

The I2C multiplexer 120 includes a relay unit 121, a path control register 122, a mode control register 123, and a buffer 124.

The relay unit 121 relays communication between the I2C control unit 110 and the repeaters 130, 130a, 130b, and 130c. In response to an instruction from the I2C control unit 110, the relay unit 121 controls which one of the I2C buses 42, 43, 44, and 45 is to be activated. According to responses (ACK or NACK) received from the repeaters 130, 130a, 130b, and 130c, the relay unit 121 returns a response to the I2C control unit 110.

The path control register 122 is a register used to manage active I2C buses and inactive I2C buses among the I2C buses 42, 43, 44, and 45.

The mode control register 123 is a register for setting an operation mode of the relay unit 121. There are two operation modes which may be set. The first mode is a mode to communicate with one of the repeaters 130, 130a, 130b, and 130c. The first mode may also be considered as a mode to activate one of the I2C buses 42, 43, 44, and 45. In the following description, the first mode may be referred to as a normal mode.

The second mode is a mode to simultaneously communicate with all the I2C buses 42, 43, 44, and 45. The second mode may also be considered as a mode to activate all the I2C buses. In the following description, the second mode may be referred to as a multimode.

The buffer 124 is used to store data to be relayed by the relay unit 121. The buffer 124 is used to manage response information (ACK or NACK) to be transmitted to the I2C control unit 110 by the relay unit 121.

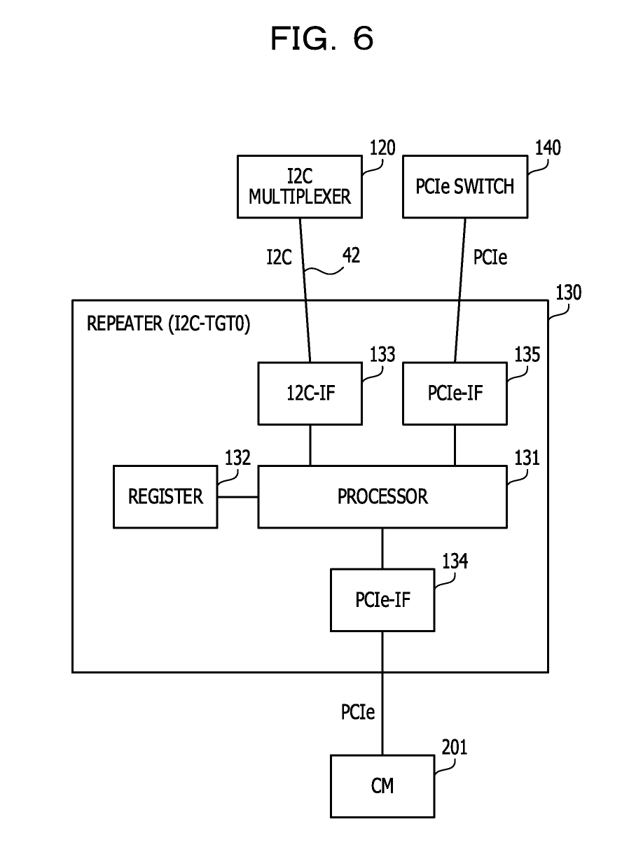

FIG. 6 is a diagram illustrating a hardware example of the repeater. The repeater 130 includes a processor 131, a register 132, an I2C-IF 133, and PCIe-IFs 134 and 135. The repeaters 130a, 130b, and 130c are also realized by the same hardware as that of the repeater 130.

The processor 131 controls operations of the repeater 130. The processor 131 is, for example, a CPU, a DSP, an ASIC, an FPGA or the like.

The register 132 stores operation settings of the repeater 130. The contents of the operation settings of the repeater 130 are specified by the I2C control unit 110 and stored in the register 132. The repeater 130 may also include a non-volatile memory such as a flash memory and a volatile memory such as a RAM, in addition to the register 132.

The I2C-IF 133 is an interface for connecting to the I2C bus 42. The I2C-IF 133 is coupled to the I2C multiplexer 120 through the I2C bus 42.

The PCIe-IF 134 is an interface for connecting to the CM 201 through a PCIe bus. The PCIe-IF 135 is an interface for connecting to the PCIe switch 140 through a PCIe bus.

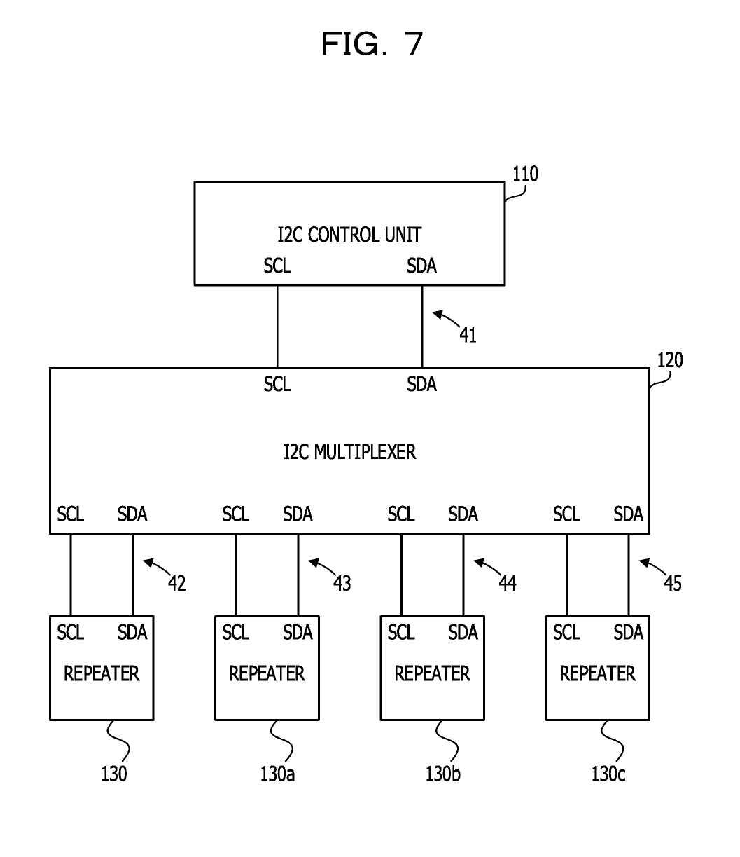

FIG. 7 is a diagram illustrating an example of the I2C bus. In the I2C, two signal lines called serial clock (SCL) and serial data (SDA) are used. Both of the signal lines are used for bidirectional communication. The I2C buses 41, 42, 43, 44, and 45 include the SCL and the SDA. The SCL and the SDA are coupled to a positive power-supply voltage through a pull-up resistor (FIG. 7 omits the illustration of the pull-up resistor). When the I2C bus is in a free state, the SCL and the SDA are both HIGH.

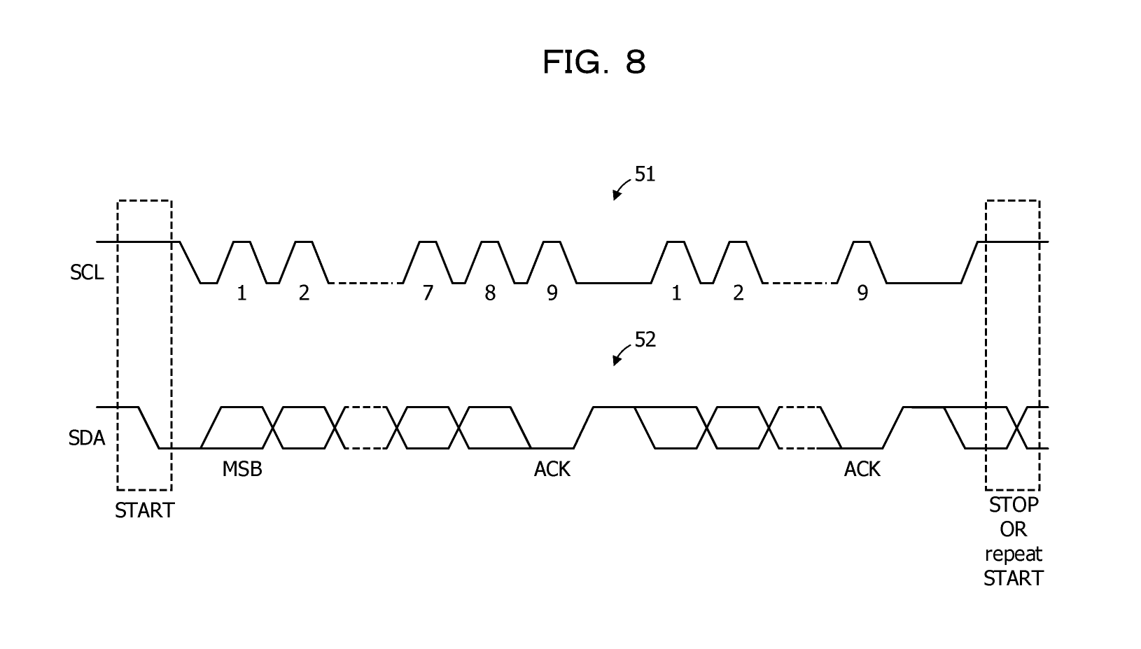

FIG. 8 is a diagram illustrating an example of a timing chart of the I2C bus. A signal 51 is a signal example of the SCL. A signal 52 is a signal example of the SDA. The communication on the I2C bus is started by transmission of a start bit (start condition) by the I2C_MST (master device). The start bit corresponds to the condition that the SDA changes from HIGH to LOW when the SCL is HIGH. The communication on the I2C bus is terminated by transmission of a stop bit (stop condition) by the I2C_MST. The stop bit corresponds to the condition that the SDA changes from LOW to HIGH when the SCL is HIGH. The I2C_MST may also transmit a repeat start bit to stop the current data transmission and perform data retransmission, or the like. The repeat start bit is the same as the start bit (corresponding to the condition that the SDA changes from HIGH to LOW when the SCL is HIGH).

On the SDA, data is transmitted by 8 bits (1 byte). The data is transmitted from the most significant bit (MSB). The ACK bit from the reception side follows after every transmission of 8 bits. For example, the SCL may be maintained LOW on the I2C_TGT (target device) side, thereby forcibly setting the I2C_MST in a standby state. To be more specific, the I2C_MST may be placed on standby until preparation for next data transmission or reception is completed during execution of internal interrupt processing or other functions on the I2C_TGT side. In this case, upon completion of the preparation, the I2C_TGT changes the SCL from LOW to HIGH, and resumes the data transfer.

The ACK bit corresponds to the ninth clock pulse after the transmission of 8 bits (8 bits of SDA corresponding to the first to eighth clock pulses of the SCL). During the period of the ninth clock pulse, the I2C_MST releases the SDA line. When returning the ACK, the I2C_TGT (or the I2C_MUX) maintains the SDA at LOW during a period when the ninth clock pulse is HIGH. On the other hand, the NACK is generated when the SDA is HIGH during a period when the ninth clock pulse is HIGH. The I2C_MST may generate the NACK when instructing the I2C_TGT to terminate the data transfer.

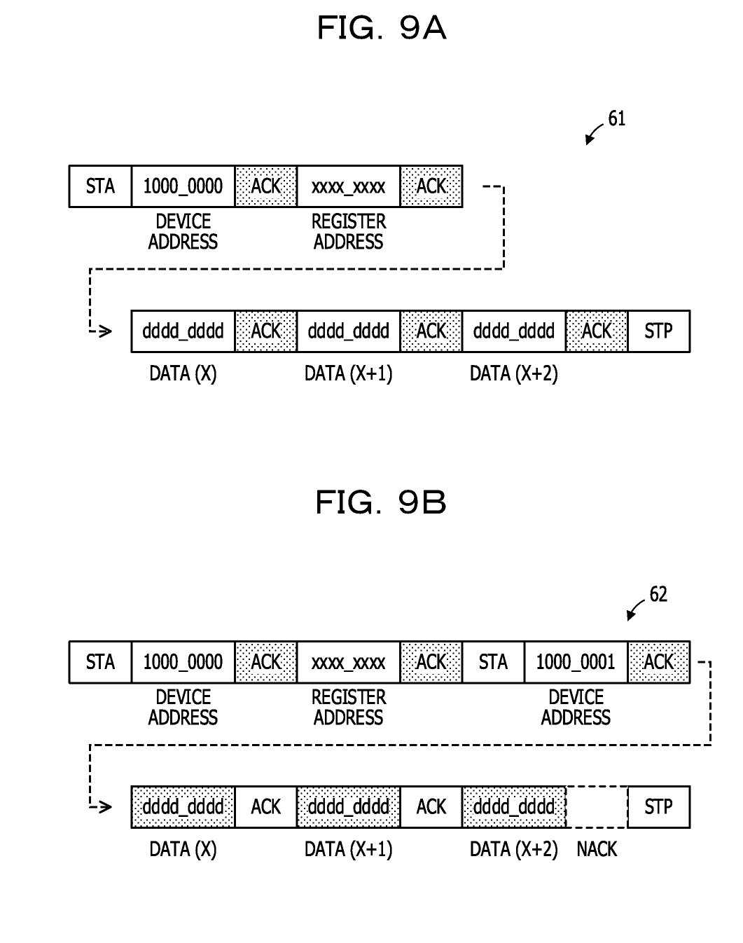

FIGS. 9A and 9B are diagrams illustrating examples of a communication format of the I2C bus. FIG. 9A illustrates a communication format 61 during data Write to the I2C_TGT. FIG. 9B illustrates a communication format 62 during data Read from the I2C_TGT. The portions indicated by the white rectangles in the communication formats 61 and 62 are information to be transmitted from the I2C_MST to the I2C_TGT. The portions indicated by the shaded rectangles in the communication formats 61 and 62 are information to be transmitted from the I2C_TGT to the I2C_MST.

The communication format 61 includes STA (start), device address, ACK, register address, ACK, data (X), ACK, data (X+1), ACK, data (X+2), ACK, and STP (stop). The respective pieces of information are transferred in this order (note, however, that the transfer direction varies depending on whether the information is the white rectangle or the shaded rectangle as described above).

The STA is a start bit.

The device address is an address of the target devices (repeaters 130, 130a, 130b, and 130c). Here, the repeaters 130, 130a, 130b, and 130c have a common device address. The upper 7 bits of the device address are device identification information. The least significant 1 bit of the device address is a command bit for instructing Write or Read. Write is instructed when the least significant 1 bit of the device address is “0”, and Read is instructed when the least significant 1 bit of the device address is “1”.

The ACK is an ACK bit for transmitting ACK or NACK (the same applies to other ACKs).

The register address is a head register address for Write in the target device. An arbitrary address may be specified as the register address.

The data (X) is Write data for the specified register address (address specified by “xxxx_xxxx”). The data (X+1) is Write data for a register address next to the register address having the data (X) written thereto. The data (X+2) is Write data for a register address next to the register address having the data (X+1) written thereto. The communication format 61 is an example of 3 bytes of Write data in total. However, the Write data may be other than 3 bytes.

The STP is a stop bit.

The communication format 62 includes STA, device address, ACK, register address, ACK, STA, device address, ACK, data (X), ACK, data (X+1), ACK, data (X+2), NACK, and STP. The respective pieces of information are transferred in this order (note, however, that the transfer direction varies depending on whether the information is the white rectangle or the shaded rectangle as described above).

The description of the STA, device address, ACK, register address, data (X), data (X+1), data (X+2), and STP is the same as that of the communication format 62. The NACK indicates that NACK is transmitted as the ACK bit.

The communication format 62 is different from the communication format 61 in that a start bit (repeat start bit) is transmitted after a Write device address (“1000_0000”) and a register address are specified, and subsequently a Read device address (“1000_0001”) is specified. This is because, during Read, a register address for Read is specified by a Write command. In the example of the communication format 62, Read is performed for the data (X), data (X+1), and data (X+2) in this order, starting from the data (X) stored in the address specified by the register address “xxxx_xxxx” in the target device. The communication format 62 is an example of 3 bytes of Read data in total. However, the Read data may be other than 3 bytes. In the following description, Write may be referred to as write processing (in other words, data transmission from the master side to the target side) and Read may be referred to as read processing (in other words, data transmission from the target side to the master side).

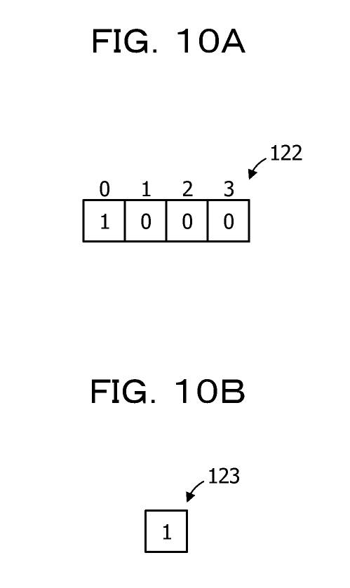

FIGS. 10A and 10B are diagrams illustrating examples of registers in the I2C multiplexer. FIG. 10A illustrates the path control register 122. FIG. 10B illustrates the mode control register 123.

The path control register 122 is a register for controlling activation and deactivation of the I2C buses 42, 43, 44, and 45 in the case of the normal mode. The path control register 122 is a 4-bit register, for example, and the respective bits correspond to the I2C buses 42, 43, 44, and 45. For example, the bit having the address “0” corresponds to the I2C bus 42. The bit having the address “1” corresponds to the I2C bus 43. The bit having the address “2” corresponds to the I2C bus 44. The bit having the address “3” corresponds to the I2C bus 45. As for the set value of each bit, “0” indicates that the corresponding I2C bus is inactive, and “1” indicates that the corresponding I2C bus is active. In the example of FIG. 10A, the set value for the path control register 122 is “1000”. In this case, the I2C bus 42 is active, and the I2C buses 43, 44, and 45 are inactive.

The mode control register 123 is a register for setting in which one of the normal mode and the multimode the I2C multiplexer 120 is to be operated. The mode control register 123 is a 1-bit register, for example. As for the set value of the mode control register 123, “0” represents the normal mode and “1” represents the multimode. In the case of the multimode, the I2C buses 42, 43, 44, and 45 are set active regardless of the set value for the path control register 122. However, in the case of the multimode, the controls by the path control register 122 may be combined (such as activating two or three of the four I2C buses).

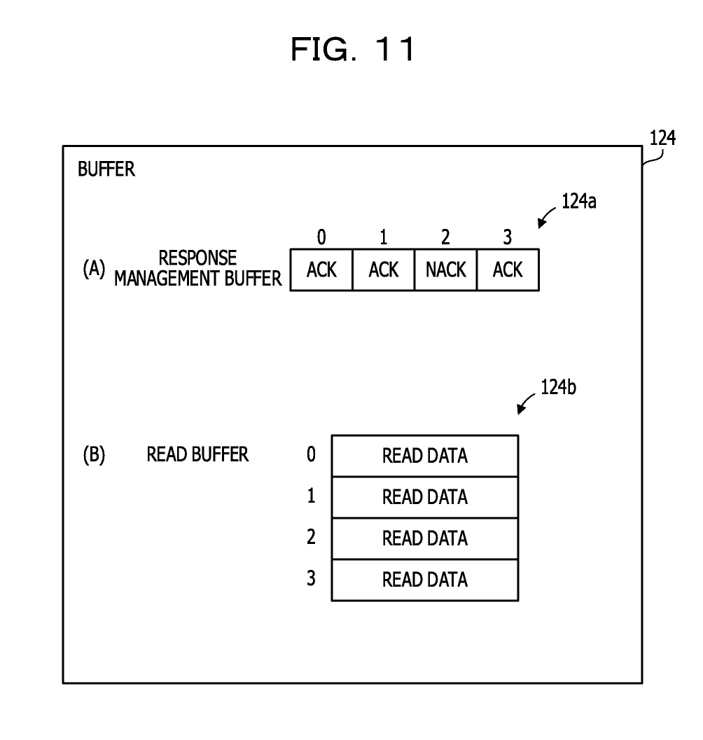

FIG. 11 is a diagram illustrating an example of the buffer in the I2C multiplexer. In FIG. 11, (A) illustrates a response management buffer 124a and (B) illustrates a read buffer 124b. The response management buffer 124a and the read buffer 124b are included in the buffer 124.

The response management buffer 124a is a buffer for holding reception confirmation responses from the repeaters 130, 130a, 130b, and 130c to the data transmission by the I2C control unit 110, when the I2C multiplexer operates in the multimode. The response management buffer 124a is a 4-bit register, for example, and the respective bits correspond to the I2C buses 42, 43, 44, and 45. For example, the bit having the address “0” corresponds to the I2C bus 42 (the repeater 130). The bit having the address “1” corresponds to the I2C bus 43 (the repeater 130a). The bit having the address “2” corresponds to the I2C bus 44 (the repeater 130b). The bit having the address “3” corresponds to the I2C bus 45 (the repeater 130c). For example, “0” of each bit is associated with ACK and “1” is associated with NACK (in the example of (A), ACK and NACK are described to clarify the contents of information).

The relay unit 121 receives the reception confirmation responses from the repeaters 130, 130a, 130b, and 130c through the I2C buses 42, 43, 44, and 45, respectively, and stores the reception confirmation responses in the response management buffer 124a. The relay unit 121 sends ACK to the I2C control unit 110 when the bits in the response management buffer 124a are all ACK, and sends NACK to the I2C control unit 110 when at least one of the bits in the response management buffer 124a is NACK. In the example of (A), ACK is received from the repeaters 130, 130a, and 130c, and NACK is received from the repeater 130b. In this case, the relay unit 121 sends NACK to the I2C control unit 110.

The read buffer 124b is a buffer for storing data (read data) read from the repeaters 130, 130a, 130b, and 130c. In the read buffer 124b, four records are provided, which correspond to the I2C buses 42, 43, 44, and 45 (the repeaters 130, 130a, 130b, and 130c). The record having the record number “0” is the read data from the repeater 130 corresponding to the I2C bus 42. The record having the record number “1” is the read data from the repeater 130a corresponding to the I2C bus 43. The record having the record number “2” is the read data from the repeater 130b corresponding to the I2C bus 44. The record having the record number “3” is the read data from the repeater 130c corresponding to the I2C bus 45.

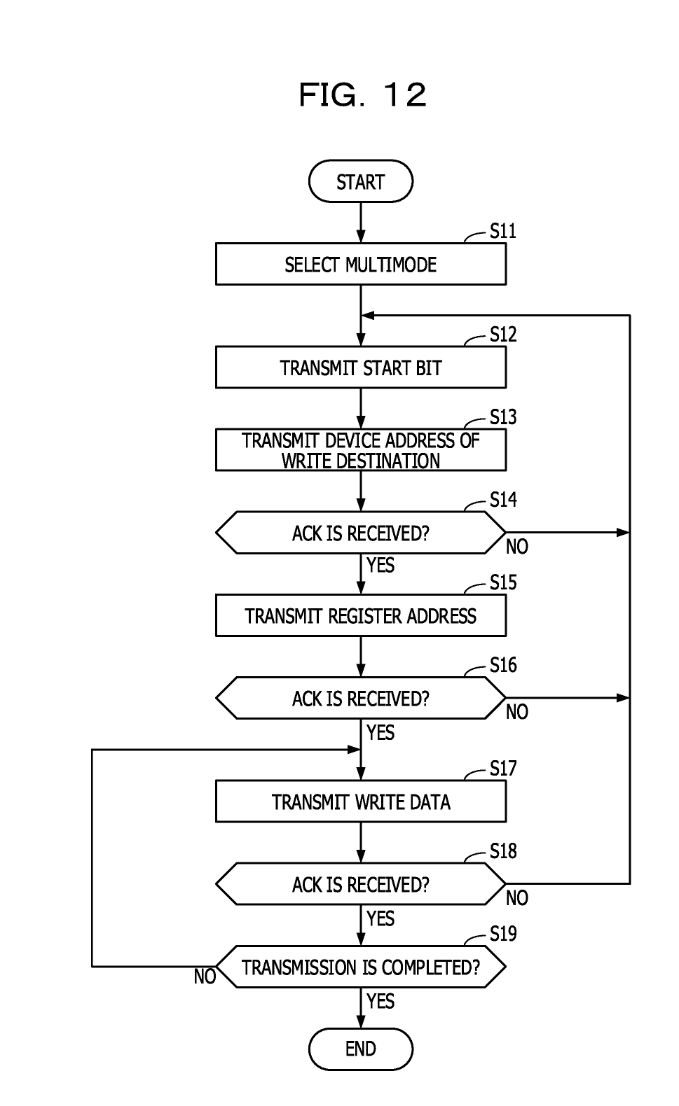

FIG. 12 is a flowchart illustrating an example of the write processing by the I2C control unit. Hereinafter, the processing illustrated in FIG. 12 is described along the processing numbers.

(S11) When common operation setting is performed for the repeaters 130, 130a, 130b, and 130c, the I2C control unit 110 instructs the I2C multiplexer 120 to select the multimode. To be more specific, the I2C control unit 110 sets the mode control register 123 to “1”.

(S12) The I2C control unit 110 transmits a start bit.

(S13) The I2C control unit 110 transmits a device address of a write destination. For example, the device address is “1000_0000”.

(S14) The I2C control unit 110 determines whether or not ACK is received. When ACK is received, the processing advances to S15. When no ACK is received (in other words, NACK is received), the processing advances to S12. When advancing to S12, the I2C control unit 110 transmits a start bit (which may be called a repeat start bit in this case) again to try retransmission from the device address.

(S15) The I2C control unit 110 transmits a register address of a write destination. As described above, an arbitrary 8-bit address may be specified as the register address.

(S16) The I2C control unit 110 determines whether or not ACK is received. When ACK is received, the processing advances to S17. When no ACK is received (in other words, NACK is received), the processing advances to S12. When advancing to S12, the I2C control unit 110 transmits a start bit again to try retransmission from the device address.

(S17) The I2C control unit 110 transmits 8-bit write data (data indicating the contents of the operation setting).

(S18) The I2C control unit 110 determines whether or not ACK is received. When ACK is received, the processing advances to S19. When no ACK is received (in other words, NACK is received), the processing advances to S12. When advancing to S12, the I2C control unit 110 transmits a start bit again to try retransmission from the device address.

(S19) The I2C control unit 110 determines whether to complete the data transmission. When the data transmission is to be completed, NACK and a stop bit are transmitted to terminate the processing. When the data transmission is not to be completed, the processing advances to S17.

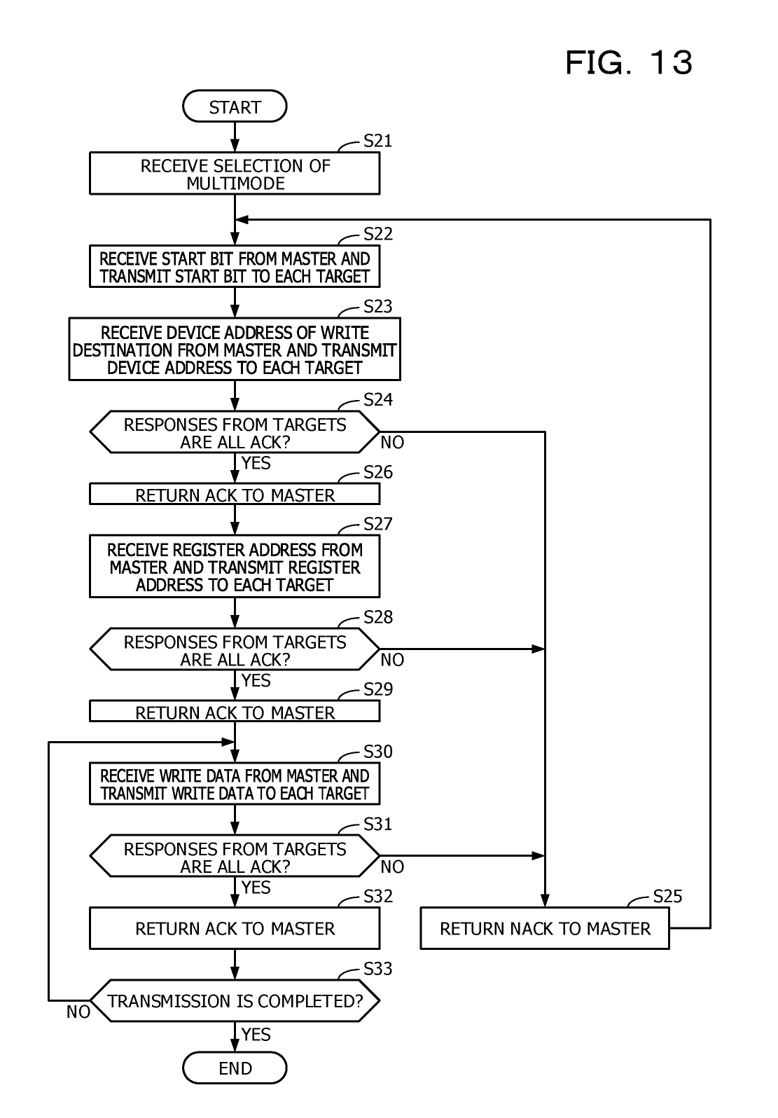

FIG. 13 is a flowchart illustrating an example of the write processing by the I2C multiplexer. Hereinafter, the processing illustrated in FIG. 13 is described along the processing numbers. In FIG. 13, the I2C control unit 110 may be described as the “master” and the repeaters 130, 130a, 130b, and 130c may be described as the “targets”.

(S21) The I2C multiplexer 120 receives the selection of the multimode by the I2C control unit 110. To be more specific, the mode control register 123 is set to “1”. The I2C multiplexer 120 activates the I2C buses 42, 43, 44, and 45.

(S22) The I2C multiplexer 120 receives the start bit from the I2C control unit 110 (master). The I2C multiplexer 120 transmits the start bit to the repeaters 130, 130a, 130b, and 130c (targets). Upon receipt of the start bit, the I2C multiplexer 120 and the repeaters 130, 130a, 130b, and 130c may recognize the start of new communication.

(S23) The I2C multiplexer 120 receives the device address of the write destination from the I2C control unit 110 (master). The I2C multiplexer 120 transmits the received device address to the repeaters 130, 130a, 130b, and 130c (targets). Here, as for the device address “1000_0000”, the upper 7 bits are the common identifier of the repeaters 130, 130a, 130b, and 130c. The least significant 1 bit represents Write.

(S24) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S26. When not all the responses are ACK (in other words, there is at least one NACK), the processing advances to S25.

(S25) The I2C multiplexer 120 returns NACK to the I2C control unit 110 (master). The I2C multiplexer 120 resets the set value in the response management buffer 124a to an initial value. Then, the I2C multiplexer 120 advances the processing to S22 (resumes the procedures from S22 (retransmission phase)).

(S26) The I2C multiplexer 120 returns ACK to the I2C control unit 110 (master). The I2C multiplexer 120 resets the set value in the response management buffer 124a to the initial value.

(S27) The I2C multiplexer 120 receives a register address from the I2C control unit 110 (master). The I2C multiplexer 120 transmits the received register address to the repeaters 130, 130a, 130b, and 130c (targets).

(S28) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S29. When not all the responses are ACK (in other words, there is at least one NACK), the processing advances to S25.

(S29) The I2C multiplexer 120 returns ACK to the I2C control unit 110 (master). The I2C multiplexer 120 resets the set value in the response management buffer 124a to the initial value.

(S30) The I2C multiplexer 120 receives write data from the I2C control unit 110 (master). The I2C multiplexer 120 transmits the received write data to the repeaters 130, 130a, 130b, and 130c (targets).

(S31) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S32. When not all the responses are ACK (in other words, there is at least one NACK), the processing advances to S25.

(S32) The I2C multiplexer 120 returns ACK to the I2C control unit 110 (master). The I2C multiplexer 120 resets the set value in the response management buffer 124a to the initial value.

(S33) The I2C multiplexer 120 determines whether or not the transmission is completed. When the transmission is completed, the processing is terminated. When the transmission is not completed, the processing advances to S30. Upon receipt of the NACK and stop bit from the I2C control unit 110, the I2C multiplexer 120 determines that the transmission is completed. In this event, the I2C multiplexer 120 transmits the NACK and stop bit to the repeaters 130, 130a, 130b, and 130c. Upon receipt of the NACK and stop bit, the repeaters 130, 130a, 130b, and 130c determines that the data transmission is completed.

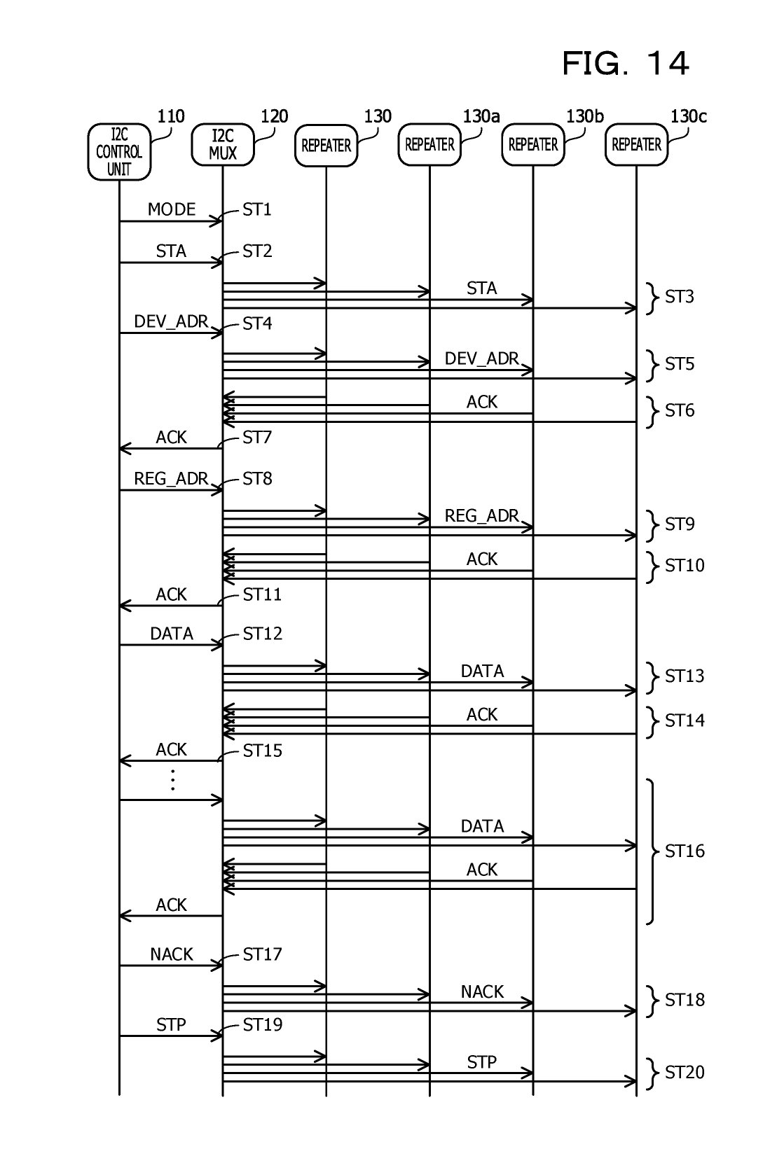

Next, description is given of a specific example of a communication sequence between devices according to the procedures illustrated in FIGS. 12 and 13. In FIG. 14, the “I2C multiplexer” may be abbreviated as the “I2C MUX”.

FIG. 14 is a diagram illustrating a sequence example of the write processing. Hereinafter, the processing illustrated in FIG. 14 is described along the processing numbers.

(ST1) The I2C control unit 110 sets the operation mode of the I2C multiplexer 120 to the multimode. The I2C multiplexer 120 activates the I2C buses 42, 43, 44, and 45.

(ST2) The I2C control unit 110 transmits a start bit. The I2C multiplexer 120 receives the start bit.

(ST3) The I2C multiplexer 120 transfers the start bit to the repeaters 130, 130a, 130b, and 130c. The repeaters 130, 130a, 130b, and 130c receive the start bit.

(ST4) The I2C control unit 110 transmits a device address. The device address is a Write address “1000_0000” for the repeaters 130, 130a, 130b, and 130c. The I2C multiplexer 120 receives the device address.

(ST5) The I2C multiplexer 120 transfers the device address to the repeaters 130, 130a, 130b, and 130c. The repeaters 130, 130a, 130b, and 130c receive the device address.

(ST6) The repeaters 130, 130a, 130b, and 130c transmit ACK. The I2C multiplexer 120 receives the ACK from the repeaters 130, 130a, 130b, and 130c.

(ST7) The I2C multiplexer 120 returns the ACK to the I2C control unit 110 since the responses from the repeaters 130, 130a, 130b, and 130c are all ACK. The I2C control unit 110 receives the ACK.

(ST8) The I2C control unit 110 transmits a register address. The I2C multiplexer 120 receives the register address.

(ST9) The I2C multiplexer 120 transfers the register address to the repeaters 130, 130a, 130b, and 130c. The repeaters 130, 130a, 130b, and 130c receive the register address.

(ST10) The repeaters 130, 130a, 130b, and 130c transmit ACK. The I2C multiplexer 120 receives the ACK from the repeaters 130, 130a, 130b, and 130c.

(ST11) The I2C multiplexer 120 returns the ACK to the I2C control unit 110 since the responses from the repeaters 130, 130a, 130b, and 130c are all ACK. The I2C control unit 110 receives the ACK.

(ST12) The I2C control unit 110 transmits write data regarding operation setting. The I2C multiplexer 120 receives the write data.

(ST13) The I2C multiplexer 120 transfers the write data to the repeaters 130, 130a, 130b, and 130c. The repeaters 130, 130a, 130b, and 130c receive the write data and write the data to the specified register address.

(ST14) The repeaters 130, 130a, 130b, and 130c transmit ACK. The I2C multiplexer 120 receives the ACK from the repeaters 130, 130a, 130b, and 130c.

(ST15) The I2C multiplexer 120 returns the ACK to the I2C control unit 110 since the responses from the repeaters 130, 130a, 130b, and 130c are all ACK. The I2C control unit 110 receives the ACK.

(ST16) The I2C control unit 110 transmits the write data by 8 bits to the repeaters 130, 130a, 130b, and 130c by repeatedly executing the procedures of ST12 to ST15. Then, the I2C control unit 110 receives ACK after transmitting the last 8 bits.

(ST17) The I2C control unit 110 transmits NACK to notify the end of the data transmission. The I2C multiplexer 120 receives the NACK.

(ST18) The I2C multiplexer 120 transfers the NACK to the repeaters 130, 130a, 130b, and 130c. The repeaters 130, 130a, 130b, and 130c receive the NACK.

(ST19) The I2C control unit 110 transmits a stop bit. The I2C multiplexer 120 receives the stop bit.

(ST20) The I2C multiplexer 120 transfers the stop bit to the repeaters 130, 130a, 130b, and 130c. The repeaters 130, 130a, 130b, and 130c receive the stop bit.

Thus, the I2C control unit 110 sets the I2C multiplexer 120 to the multimode when transmitting the common data to the repeaters 130, 130a, 130b, and 130c. Then, the I2C multiplexer 120 may simultaneously transmit the data to the repeaters 130, 130a, 130b, and 130c.

Note that, in FIG. 14, the description is given of the case where the responses received from the repeaters 130, 130a, 130b, and 130c are all ACK. However, NACK may be returned to the I2C multiplexer 120 from any of the repeaters. In such a case, the I2C multiplexer 120 returns NACK to the I2C control unit 110 as described above. Then, upon receipt of the NACK, the I2C control unit 110 retransmits the data by starting over from the transmission of a start bit.

Alternatively, the I2C control unit 110 may also transmit the data by the I2C multiplexer 120 selecting paths one by one. Next, a sequence in this case is described as a comparative example.

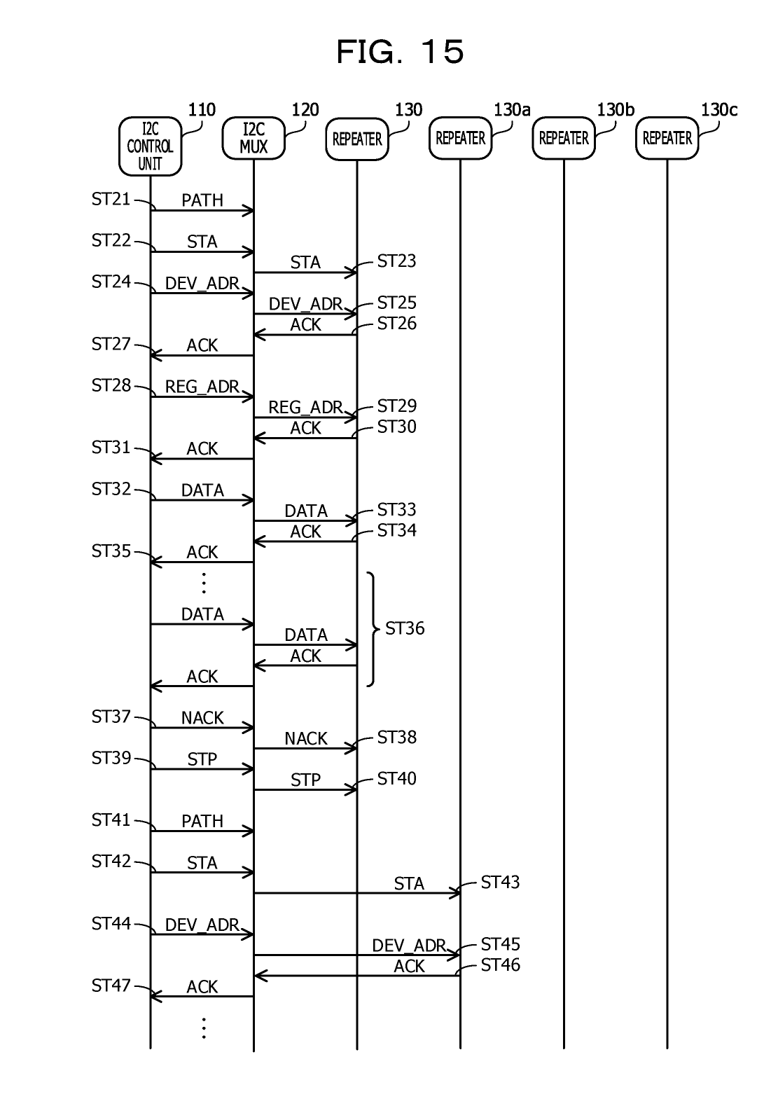

FIG. 15 is a diagram illustrating a comparative example of the sequence of the write processing. Hereinafter, the processing illustrated in FIG. 15 is described along the processing numbers.

(ST21) The I2C control unit 110 instructs the I2C multiplexer 120 to activate the path of the I2C bus 42. To be more specific, the I2C control unit 110 sets the bit corresponding to the address “0” in the path control register 122 to “1”, and sets the other bits to “0”. Then, the I2C bus 42 is activated, and the I2C buses 43, 44, and 45 are deactivated.

(ST22) The I2C control unit 110 transmits a start bit. The I2C multiplexer 120 receives the start bit.

(ST23) The I2C multiplexer 120 transfers the start bit to the repeater 130 through the active I2C bus 42. The repeater 130 receives the start bit.

(ST24) The I2C control unit 110 transmits a device address. The device address is a Write address “1000_0000” for the repeater 130. The I2C multiplexer 120 receives the device address.

(ST25) The I2C multiplexer 120 transfers the device address to the repeater 130. The repeater 130 receives the device address.

(ST26) The repeater 130 transmits ACK. The I2C multiplexer 120 receives the ACK.

(ST27) The I2C multiplexer 120 transfers the ACK to the I2C control unit 110. The I2C control unit 110 receives the ACK.

(ST28) The I2C control unit 110 transmits a register address. The I2C multiplexer 120 receives the register address.

(ST29) The I2C multiplexer 120 transfers the register address to the repeater 130. The repeater 130 receives the register address.

(ST30) The repeater 130 transmits ACK. The I2C multiplexer 120 receives the ACK.

(ST31) The I2C multiplexer 120 transfers the ACK to the I2C control unit 110. The I2C control unit 110 receives the ACK.

(ST32) The I2C control unit 110 transmits write data regarding operation setting. The I2C multiplexer 120 receives the write data.

(ST33) The I2C multiplexer 120 transfers the write data to the repeater 130. The repeater 130 receives the write data and writes the data to the specified register address.

(ST34) The repeater 130 transmits ACK. The I2C multiplexer 120 receives the ACK.

(ST35) The I2C multiplexer 120 returns the ACK to the I2C control unit 110. The I2C control unit 110 receives the ACK.

(ST36) The I2C control unit 110 transmits the write data by 8 bits to the repeater 130 by repeatedly executing the procedures of ST32 to ST35. Then, the I2C control unit 110 receives ACK after transmitting the last 8 bits.

(ST37) The I2C control unit 110 transmits NACK to notify the end of the data transmission. The I2C multiplexer 120 receives the NACK.

(ST38) The I2C multiplexer 120 transfers the NACK to the repeater 130. The repeater 130 receives the NACK.

(ST39) The I2C control unit 110 transmits a stop bit. The I2C multiplexer 120 receives the stop bit.

(ST40) The I2C multiplexer 120 transfers the stop bit to the repeater 130. The repeater 130 receives the stop bit. Thus, the data transmission from the I2C multiplexer 120 to the repeater 130 is completed.

(ST41) The I2C control unit 110 instructs the I2C multiplexer 120 to activate the path of the I2C bus 43. To be more specific, the I2C control unit 110 sets the bit corresponding to the address “1” in the path control register 122 to “1”, and sets the other bits to “0”. Then, the I2C bus 43 is activated, and the I2C buses 42, 44, and 45 are deactivated.

(ST42) The I2C control unit 110 transmits a start bit. The I2C multiplexer 120 receives the start bit.

(ST43) The I2C multiplexer 120 transfers the start bit to the repeater 130a through the active I2C bus 43. The repeater 130a receives the start bit.

(ST44) The I2C control unit 110 transmits a device address. The device address is a Write address “1000_000” for the repeater 130a. The I2C multiplexer 120 receives the device address.

(ST45) The I2C multiplexer 120 transfers the device address to the repeater 130a. The repeater 130a receives the device address.

(ST46) The repeater 130a transmits ACK. The I2C multiplexer 120 receives the ACK.

(ST47) The I2C multiplexer 120 transfers the ACK to the I2C control unit 110. The I2C control unit 110 receives the ACK.

Thereafter, the I2C control unit 110 transmits a register address and write data as in the case of the repeater 130. Upon completion of the data transmission to the repeater 130a, the I2C control unit 110 instructs the I2C multiplexer 120 to select the path to the repeater 130b, and starts data transmission to the repeater 130b in the same manner as the repeaters 130 and 130a. Furthermore, upon completion of the data transmission to the repeater 130b, the I2C control unit 110 instructs the I2C multiplexer 120 to select the path to the repeater 130c, and starts data transmission to the repeater 130c in the same manner as the repeaters 130, 130a, and 130b.

As in the comparative example, in the method for performing data transmission while selecting the paths one by one, the same data is transmitted from the I2C control unit 110 upon every path change when common data is transmitted to the repeaters 130, 130a, 130b, and 130c. However, it is inefficient to transmit the same data over and over again from the connection device. When the path selection and multiple transmission of the same data occur, it takes time to complete the data transmission to all of the repeaters 130, 130a, 130b, and 130c.

Meanwhile, the I2C control unit 110 may simultaneously transmit the common data to the repeaters 130, 130a, 130b, and 130c by setting the I2C multiplexer 120 to the multimode. Thus, the path selection and the multiple transmission of the same data by the I2C control unit 110 may not be performed. Thus, the time taken to complete the data transmission to all of the repeaters 130, 130a, 130b, and 130c can be reduced.

For example, time taken for data transmission under the following conditions is compared. (1) The I2C operation frequency is 100 kMHz. (2) The number of the I2C targets is 96. This is because the upper limit of the number of CMs which may be mounted in the storage apparatus 10 is assumed to be 24 as an example, and in that case, 96 repeaters in total are mounted in the FRTs 103, 104, 105, and 106. (3) The size of the write data is 0×52=82 bytes. The time taken for transmission of 1 byte is 300 microseconds. (4) The SVC 101 performs setting of the 96 I2C targets.

In this case, when the method of the comparative example illustrated in FIG. 15 is used, the time taken to complete the data transmission to all the targets is about 82×96×300=2361.6 milliseconds. On the other hand, when the I2C control unit 110 simultaneously transmits data by setting the I2C multiplexer 120 in the multimode, the time taken to complete the data transmission to all the targets is about 82×300=24.6 milliseconds. Therefore, when simultaneous communication is performed by using the multimode, the time is expected to be reduced by about 2 seconds or more compared with the method of the comparative example illustrated in FIG. 15.

When the multimode is selected by the mode control register 123, the I2C buses 42, 43, 44, and 45 are all activated. However, in another example, two or three I2C buses may be activated. For example, the I2C control unit 110 further sets two or three bits to “1” and the other bits to “0” in the path control register 122, in addition to the selection of the multimode. Then, the I2C multiplexer 120 activates the I2C buses corresponding to the two or three bits set to “1” in the path control register 122. Thus, the I2C control unit 110 may also simultaneously transmit data to more than one repeater coupled to some of the I2C buses 42, 43, 44, and 45.

Incidentally, in the procedures illustrated in FIG. 12, during the retransmission, the processing is started over from the transmission of a device address to all the repeaters after a start bit is transmitted again. On the other hand, the I2C control unit 110 may also perform data retransmission to only the repeater which has received NACK.

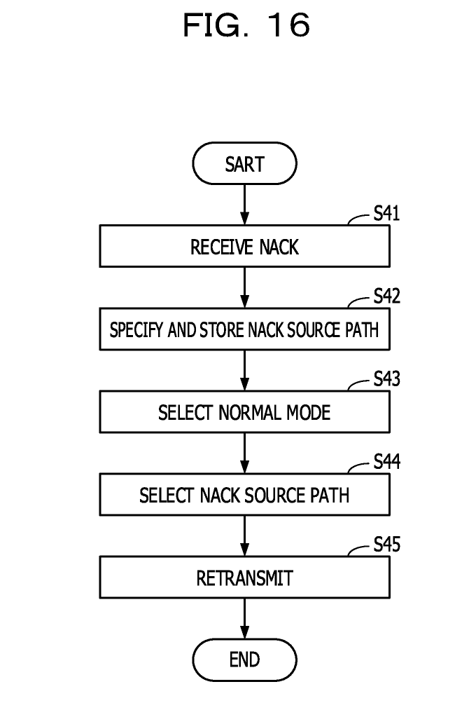

FIG. 16 is a flowchart illustrating another example of retransmission processing by the I2C control unit. Hereinafter, the processing illustrated in FIG. 16 is described along the processing numbers. The following procedures are executed during data transmission in the multimode to the repeaters 130, 130a, 130b, and 130c from the I2C control unit 110.

(S41) The I2C control unit 110 receives NACK.

(S42) The I2C control unit 110 specifies a source path of the NACK. The I2C control unit 110 may specify the source path of the NACK by reading information from the response management buffer 124a. Note that, in this case, the I2C multiplexer 120 provides the I2C control unit 110 with the information in the response management buffer 124a, and then resets the response management buffer 124a to the initial value. The I2C control unit 110 stores the information on the specified source path of the NACK in the memory 112. Thereafter, the I2C control unit 110 continues the data transmission to the other repeaters, and completes the data transmission to the other repeaters. The I2C control unit 110 may continue the data transmission to the other repeaters after setting the source path of the NACK in an inactive state.

(S43) The I2C control unit 110 instructs the I2C multiplexer 120 to select the normal mode. To be more specific, the I2C control unit 110 sets the mode control register 123 to “0”.

(S44) The I2C control unit 110 instructs the I2C multiplexer 120 to select the NACK source path (path to the target corresponding to the NACK source) stored in the memory 112. To be more specific, the I2C control unit 110 sets a bit corresponding to the NACK source path (I2C bus) in the path control register 122 to “1”, and sets the other bits to “0”.

(S45) The I2C control unit 110 retransmits data to the corresponding repeater. To be more specific, the I2C control unit 110 sequentially performs the transmission of a start bit, transmission of a device address, transmission of a register address, and transmission of write data, as described above.

As described above, the I2C control unit 110 may perform the retransmission to only the repeater of the NACK source by setting the operation mode of the I2C multiplexer 120 to the normal mode during the retransmission. By narrowing down the repeater of the retransmission target, retransmission to the other repeaters normally receiving the data may be suppressed. More specifically, repeated transmission of the same data to the other repeaters normally receiving the data may be reduced, and thus occurrence of repeated operations associated with the retransmission in the other repeaters may be suppressed. By suppressing the occurrence of undesirable operations in the repeaters, suppression of load on the repeaters and power saving may be achieved, for example.

Next, description is given of procedures when the I2C control unit 110 reads data from the repeaters 130, 130a, 130b, and 130c.

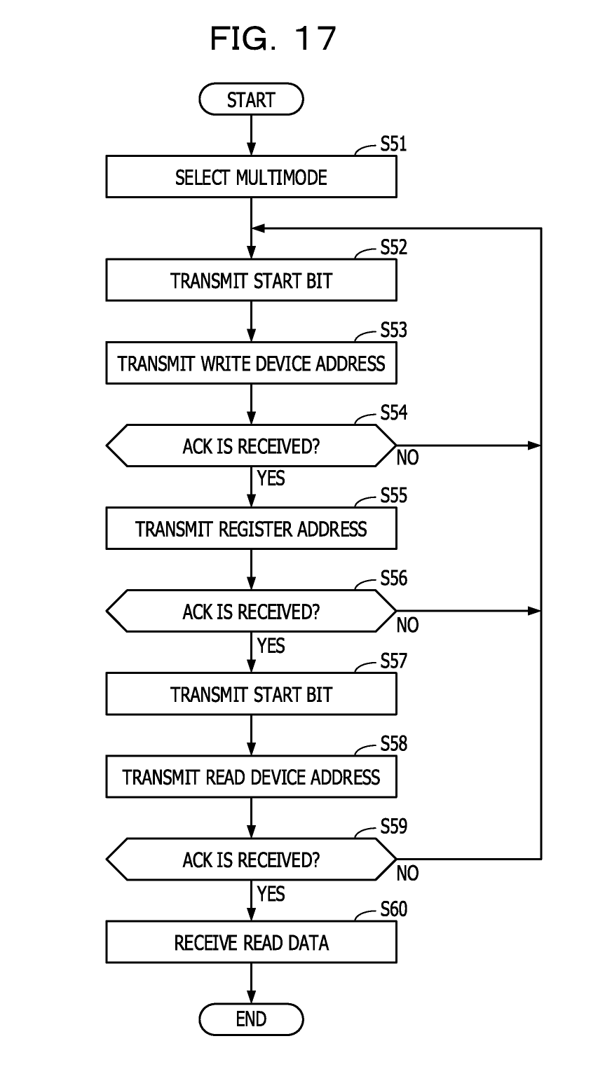

FIG. 17 is a flowchart illustrating an example of read processing by the I2C control unit. Hereinafter, the processing illustrated in FIG. 17 is described along the processing numbers.

(S51) The I2C control unit 110 instructs the I2C multiplexer 120 to select the multimode. To be more specific, the I2C control unit 110 sets the mode control register 123 to “1”.

(S52) The I2C control unit 110 transmits a start bit.

(S53) The I2C control unit 110 transmits a write device address (device address including a write command). For example, the device address is “1000_0000” (the least significant bit is “0”).

(S54) The I2C control unit 110 determines whether or not ACK is received. When ACK is received, the processing advances to S55. When no ACK is received (in other words, NACK is received), the processing advances to S52. When advancing to S52, the I2C control unit 110 transmits a start bit again to try retransmission from the device address.

(S55) The I2C control unit 110 transmits a register address. As described above, an arbitrary 8-bit address may be specified as the register address. The register address specified here is a data read source address.

(S56) The I2C control unit 110 determines whether or not ACK is received. When ACK is received, the processing advances to S57. When no ACK is received (in other words, NACK is received), the processing advances to S52. When advancing to S52, the I2C control unit 110 transmits a start bit again to try retransmission from the device address.

(S57) The I2C control unit 110 transmits a start bit.

(S58) The I2C control unit 110 transmits a device address including a read command. For example, the device address is “1000_0001” (the least significant bit is “1”).

(S59) The I2C control unit 110 determines whether or not ACK is received. When ACK is received, the processing advances to S60. When no ACK is received (in other words, NACK is received), the processing advances to S52. When advancing to S52, the I2C control unit 110 transmits a start bit again to try retransmission from the device address.

(S60) The I2C control unit 110 receives the read data transmitted by the repeaters 130, 130a, 130b, and 130c. Upon completion of the read, the I2C control unit 110 transmits NACK and a stop bit as illustrated in FIG. 9B, and notifies the repeaters 130, 130a, 130b, and 130c of the completion.

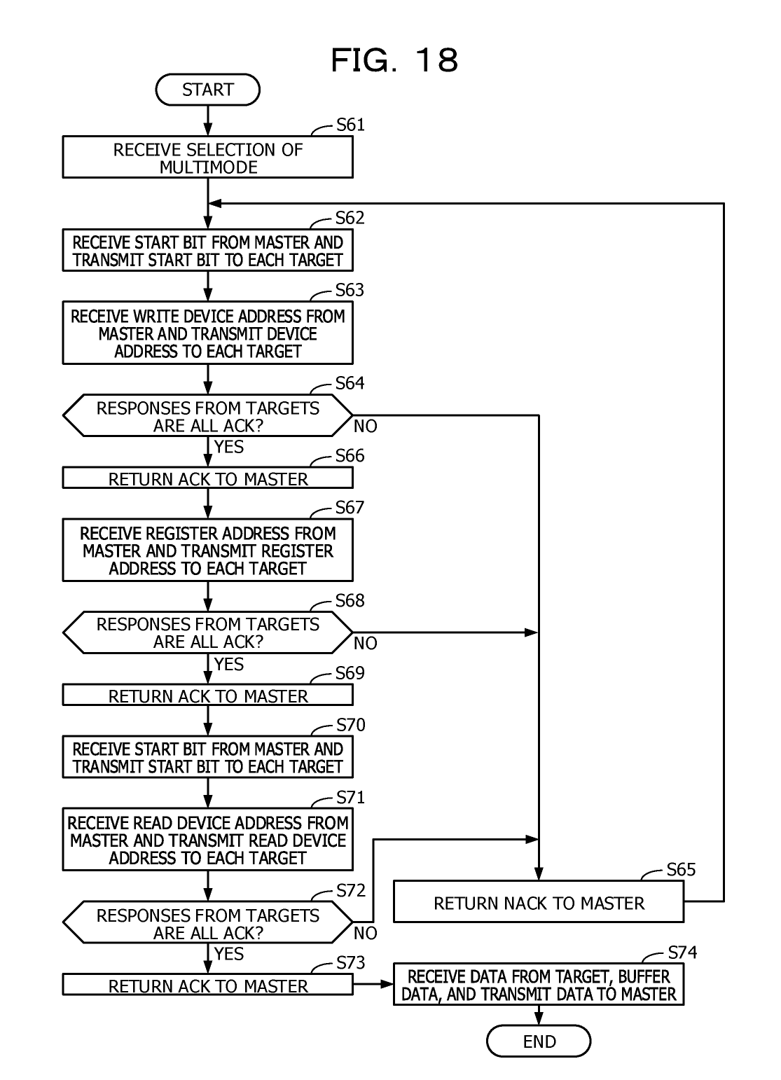

FIG. 18 is a flowchart illustrating an example of read processing by the I2C multiplexer. Hereinafter, the processing illustrated in FIG. 18 is described along the processing numbers.

(S61) The I2C multiplexer 120 receives the selection of the multimode by the I2C control unit 110. To be more specific, the mode control register 123 is set to “1”. The I2C multiplexer 120 activates the I2C buses 42, 43, 44, and 45.

(S62) The I2C multiplexer 120 receives the start bit from the I2C control unit 110 (master). The I2C multiplexer 120 transmits the start bit to the repeaters 130, 130a, 130b, and 130c (targets).

(S63) The I2C multiplexer 120 receives the device address including the write command (“1000_0000”) from the I2C control unit 110 (master). The I2C multiplexer 120 transmits the received device address to the repeaters 130, 130a, 130b, and 130c (targets).

(S64) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S66. When not all the responses are ACK (in other words, there is at least one NACK), the processing advances to S65.

(S65) The I2C multiplexer 120 returns NACK to the I2C control unit 110 (master). The I2C multiplexer 120 resets the set value in the response management buffer 124a to an initial value. Then, the I2C multiplexer 120 advances the processing to S62 (resumes the procedures from S62 (retransmission phase)).

(S66) The I2C multiplexer 120 returns ACK to the I2C control unit 110 (master). The I2C multiplexer 120 resets the set value in the response management buffer 124a to the initial value.

(S67) The I2C multiplexer 120 receives a register address from the I2C control unit 110 (master). The I2C multiplexer 120 transmits the received register address to the repeaters 130, 130a, 130b, and 130c (targets).

(S68) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S69. When not all the responses are ACK (in other words, there is at least one NACK), the processing advances to S65.

(S69) The I2C multiplexer 120 returns ACK to the I2C control unit 110 (master). The I2C multiplexer 120 resets the set value in the response management buffer 124a to the initial value.

(S70) The I2C multiplexer 120 receives a start bit from the I2C control unit 110 (master). The I2C multiplexer 120 transmits the start bit to the repeaters 130, 130a, 130b, and 130c (targets).

(S71) The I2C multiplexer 120 receives the device address including the read command (“1000_0001”) from the I2C control unit 110 (master). The I2C multiplexer 120 transmits the received device address to the repeaters 130, 130a, 130b, and 130c (targets).

(S72) The I2C multiplexer 120 receives ACK or NACK responses from the repeaters 130, 130a, 130b, and 130c (targets), and stores the received responses in the response management buffer 124a. The I2C multiplexer 120 determines, by referring to the response management buffer 124a, whether or not the responses from the repeaters 130, 130a, 130b, and 130c (targets) are all ACK. When the responses are all ACK, the processing advances to S73. When not all the responses are ACK (in other words, there is at least one NACK), the processing advances to S65.

(S73) The I2C multiplexer 120 returns ACK to the I2C control unit 110 (master). The I2C multiplexer 120 resets the set value in the response management buffer 124a to the initial value.

(S74) The I2C multiplexer 120 receives the read data transmitted from the repeaters 130, 130a, 130b, and 130c (targets), and stores the received read data in the read buffer 124b. Then, the I2C multiplexer 120 transfers the buffered read data to the I2C control unit 110 at a predetermined timing. The I2C multiplexer 120 may provide the I2C control unit 110 with the read data associated with identification information (for example, the bus number) of each of the I2C buses 42, 43, 44, and 45.

The I2C multiplexer 120 may transmit dummy data to the I2C control unit 110 during buffering, in order to allow the I2C control unit 110 to generate ACK. Then, the I2C multiplexer 120 may sequentially receive the read data from the repeaters 130, 130a, 130b, and 130c to perform the buffering. When a certain amount of data is buffered, the I2C multiplexer 120 may transfer the buffered data to the I2C control unit 110.

Next, description is given of a specific example of a communication sequence between devices according to the procedures illustrated in FIGS. 17 and 18.

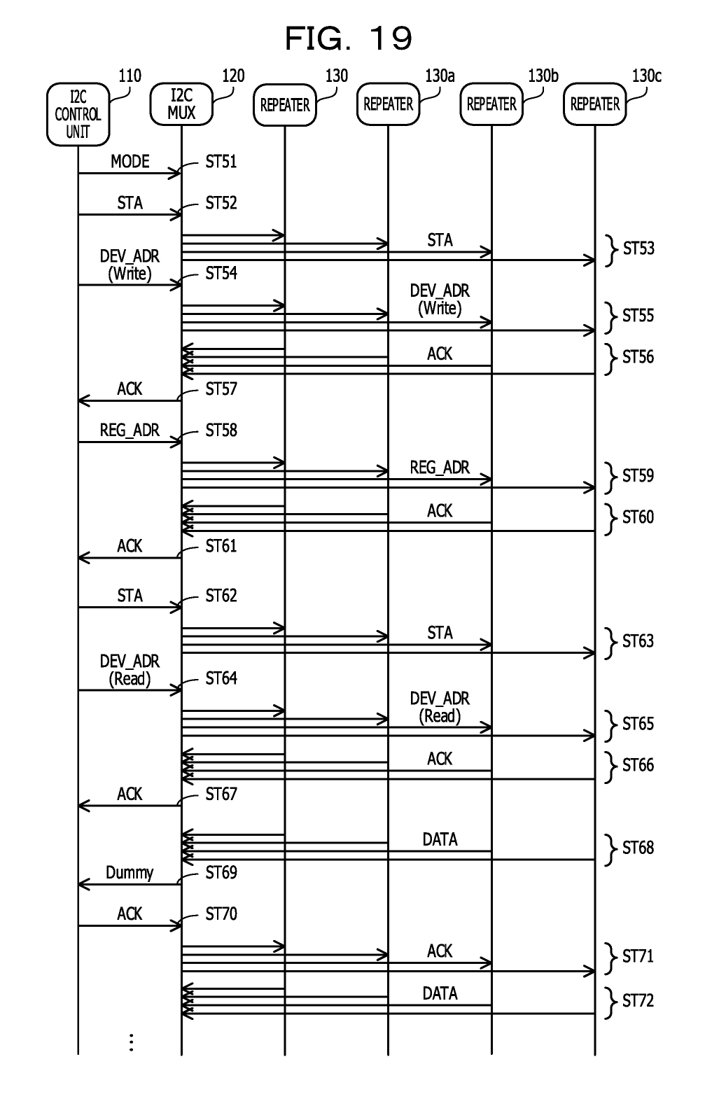

FIG. 19 is a diagram illustrating a sequence example of the read processing. Hereinafter, the processing illustrated in FIG. 19 is described along the processing numbers.

(ST51) The I2C control unit 110 sets the operation mode of the I2C multiplexer 120 to the multimode. The I2C multiplexer 120 activates the I2C buses 42, 43, 44, and 45.

(ST52) The I2C control unit 110 transmits a start bit. The I2C multiplexer 120 receives the start bit.

(ST53) The I2C multiplexer 120 transfers the start bit to the repeaters 130, 130a, 130b, and 130c. The repeaters 130, 130a, 130b, and 130c receive the start bit.

(ST54) The I2C control unit 110 transmits a device address. The device address is a Write address “1000_0000” for the repeaters 130, 130a, 130b, and 130c. The I2C multiplexer 120 receives the device address.

(ST55) The I2C multiplexer 120 transfers the device address to the repeaters 130, 130a, 130b, and 130c. The repeaters 130, 130a, 130b, and 130c receive the device address.

(ST56) The repeaters 130, 130a, 130b, and 130c transmit ACK. The I2C multiplexer 120 receives the ACK from the repeaters 130, 130a, 130b, and 130c.

(ST57) The I2C multiplexer 120 returns the ACK to the I2C control unit 110 since the responses from the repeaters 130, 130a, 130b, and 130c are all ACK. The I2C control unit 110 receives the ACK.

(ST58) The I2C control unit 110 transmits a register address. The I2C multiplexer 120 receives the register address.

(ST59) The I2C multiplexer 120 transfers the register address to the repeaters 130, 130a, 130b, and 130c. The repeaters 130, 130a, 130b, and 130c receive the register address.

(ST60) The repeaters 130, 130a, 130b, and 130c transmit ACK. The I2C multiplexer 120 receives the ACK from the repeaters 130, 130a, 130b, and 130c.

(ST61) The I2C multiplexer 120 returns the ACK to the I2C control unit 110 since the responses from the repeaters 130, 130a, 130b, and 130c are all ACK. The I2C control unit 110 receives the ACK.

(ST62) The I2C control unit 110 transmits a start bit. The I2C multiplexer 120 receives the start bit.

(ST63) The I2C multiplexer 120 transfers the start bit to the repeaters 130, 130a, 130b, and 130c. The repeaters 130, 130a, 130b, and 130c receive the start bit.

(ST64) The I2C control unit 110 transmits a device address. The device address is a Read address “1000_0001” for the repeaters 130, 130a, 130b, and 130c. The I2C multiplexer 120 receives the device address.

(ST65) The I2C multiplexer 120 transfers the device address to the repeaters 130, 130a, 130b, and 130c. The repeaters 130, 130a, 130b, and 130c receive the device address.

(ST66) The repeaters 130, 130a, 130b, and 130c transmit ACK. The I2C multiplexer 120 receives the ACK from the repeaters 130, 130a, 130b, and 130c.

(ST67) The I2C multiplexer 120 returns the ACK to the I2C control unit 110 since the responses from the repeaters 130, 130a, 130b, and 130c are all ACK. The I2C control unit 110 receives the ACK.

(ST68) The repeaters 130, 130a, 130b, and 130c transmit read data read from the specified register address. The I2C multiplexer 120 receives the read data from the repeaters 130, 130a, 130b, and 130c, and performs buffering using the read buffer 124b.

(ST69) The I2C multiplexer 120 transmits dummy data to the I2C control unit 110. The I2C control unit 110 receives the dummy data.

(ST70) The I2C control unit 110 transmits ACK. The I2C multiplexer 120 receives the ACK.

(ST71) The I2C multiplexer 120 transmits ACK to the repeaters 130, 130a, 130b, and 130c. The repeaters 130, 130a, 130b, and 130c receive the ACK.

(ST72) The repeaters 130, 130a, 130b, and 130c transmit next read data. The I2C multiplexer 120 receives the next read data and performs buffering using the read buffer 124b.

The I2C control unit 110 acquires data of each repeater, which is buffered by the I2C multiplexer 120, at a predetermined timing. While acquiring the buffered data, the I2C control unit 110 temporarily stops the data transmission from the repeaters 130, 130a, 130b, and 130c.

Thus, the I2C control unit 110 may efficiently read the data from the repeaters 130, 130a, 130b, and 130c. To be more specific, once the multimode is selected in ST51, the start bit, device address, and register address may be simultaneously transmitted to the repeaters 130, 130a, 130b, and 130c by the I2C multiplexer 120. Thus, the communication time may be reduced compared with the case where the data is read by transmitting the start bit, device address, and register address more than once from the I2C control unit 110 while selecting the I2C buses one by one.

Note that, in the description of the second embodiment, the repeaters 130, 130a, 130b, and 130c have the common device address. However, the repeaters 130, 130a, 130b, and 130c may have different device addresses. In such a case, the I2C control unit 110 transmits a predetermined device address in the multimode of the I2C multiplexer 120, for example. Then, the I2C multiplexer 120 rewrites the device address to the device addresses of the repeaters 130, 130a, 130b, and 130c, and transmits the device addresses to the repeaters 130, 130a, 130b, and 130c. The other information such as the start bit and the register address may be transmitted in the same manner as the method described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus comprising:
a relay device;
a connection device coupled to the relay device through a bus; and
a plurality of target devices coupled to the connection device,
wherein the connection device is configured to:
switch an operation mode of the relay device to a first mode to activate a path between the relay device and the one target device, when communication is performed between the connection device and one of the plurality of target devices, and
switch the operation mode of the relay device to a second mode to activate paths between the relay device and the two or more target devices, when communication is simultaneously performed between the connection device and two or more of the plurality of target devices.

2. The storage apparatus according to claim 1,
wherein the connection device is configured to indicate, to the relay device, one or more paths to be activated, among a plurality of paths connecting between the connection device and the plurality of target devices when transmitting an instruction to switch to the first mode or the second mode.

3. The storage apparatus according to claim 1,
wherein the connection device is configured to set the operation mode of the relay device to the second mode when common data is transmitted to the two or more target devices from the connection device.

4. The storage apparatus according to claim 3,
wherein the relay device is configured to transmit a positive response to the connection device upon receipt of positive responses from all of the two or more target devices after the common data is transmitted from the connection device.

5. The storage apparatus according to claim 3,
wherein the relay device is configured to transmit a negative response to the connection device upon receipt of a negative response from at least one of the two or more target devices after the common data is transmitted from the connection device.

6. The storage apparatus according to claim 5,
wherein the connection device is configured to:
receive information indicating a target device which has transmitted the negative response from the relay device,
set the operation mode of the relay device to the first mode, and
retransmit the common data to the target device which has transmitted the negative response.

7. The storage apparatus according to claim 1,
wherein the bus is a serial bus for bidirectional communication using two signal lines, a clock line and a data line.

8. A control method executed by a storage apparatus including a relay device, a connection device coupled to the relay device through a bus, and a plurality of target devices coupled to the connection device, the control method comprising:
switching, by the connection device, an operation mode of the relay device to a first mode to activate a path between the relay device and the one target device, when communication is performed between the connection device and one of the plurality of target devices; and
switching, by the connection device, the operation mode of the relay device to a second mode to activate paths between the relay device and the two or more target devices, when communication is simultaneously performed between the connection device and two or more of the plurality of target devices.

9. The control method according to claim 8, wherein the switching includes
indicating, to the relay device, one or more paths to be activated, among a plurality of paths connecting between the connection device and the plurality of target devices when transmitting an instruction to switch to the first mode or the second mode.

10. The control method according to claim 8, further comprising
setting the operation mode of the relay device to the second mode when common data is transmitted to the two or more target devices from the connection device.

11. The control method according to claim 8, further comprising
setting the operation mode of the relay device to the second mode when common data is transmitted to the two or more target devices from the connection device.

12. A connection device coupled to a relay device through a bus and configured to communicate with a plurality of target devices through the bus and the relay device, the connection device comprising:
a memory; and
a processor coupled to the memory and configured to:
switch an operation mode of the relay device to a first mode to activate a path between the relay device and the one target device, when communicating with one of the plurality of target devices, and
switch the operation mode of the relay device to a second mode to activate paths between the relay device and the two or more target devices, when simultaneously communicating with two or more of the plurality of target devices.
